(19) United States
(12) Patent Application Publication
(10) Pub. No.: US 2003/0078688 A1
(43) Pub. Date: Apr. 24, 2003

(54) Neuronal network for determining proportions of components of a formulation for producing a product of a desired color

(76) Inventor: Bahman Sarabi, Krefeld (DE)

Correspondence Address: BAYER CORPORATION, 100 BAYER ROAD, PITTSBURGH, PA, 15205, US

(21) Appl. No.: 10/271,701

(22) Filed: Oct. 16, 2002

(30) Foreign Application Priority Data
Oct. 22, 2001 (DE) 101 52 004.2

(51) Int. Cl. G06F 19/00

(52) U.S. Cl. 700/97; 700/200; 706/23; 706/919

(57) ABSTRACT

A network (in particular a neuronal network) which is used for determining at least one proportion of at least one component of a formulation, and subsequently for the production of a product (e.g., a molded article) having a pre-selected (or desired) color is described. The neuronal network comprises: (a) a neuronal network (or neuronal processor); (b) at least one of, (i) an input for inputting at least one color coordinate of a component of the formulation into the neuronal processor, and (ii) an input for inputting at least one preselected color coordinate of the product into the neuronal processor; and (c) an output for outputting a proportion of at least one component of the formulation from the neuronal processor. Inputs (b)(i) and (b)(ii), and output (c) are each independently connected (e.g., electronically and/or digitally) to the neuronal processor. Also described is a method of determining the proportions of components in a formulation for producing a product (e.g., a molded article) having pre-selected (or desired) color coordinates.

### CROSS REFERENCE TO RELATED PATENT APPLICATION

The present patent application claims the right of priority under 35 U.S.C. §119 (a)-(d) of German Patent Application No. 101 52 004.2, filed Oct. 22, 2001.

### FIELD OF THE INVENTION

The invention relates to a neuronal network for determining proportions of components of a formulation for producing a product of a desired color and also to a corresponding method for training a neuronal network and a method of producing a plastic injection molding and a corresponding system.

### BACKGROUND OF THE INVENTION

U.S. Pat. No. 5,723,517 discloses a system for color matching of a compounded polymer during the production process. The color of the compounded polymer is measured at predetermined time instants by means of a sensor. The measured actual value is then compared with a specified value by a control appliance and the amounts of dyestuffs and pigments to be added to the compounded polymer are controlled correspondingly.

In particular, this system is disadvantageous insofar as appreciable amounts of dyestuffs have to be added to the compounded polymer and, in addition, the color of the final product is subject to fluctuations. A further disadvantage is that the actual value is measured with a sensor that has an appreciably lower color resolution than the human eye. The result of such a production method does not therefore meet the color fidelity requirements of a colorist and also of the end user.

Suitable methods of producing plastic injection moldings that are to have a certain color are also disclosed, for example, in U.S. Pat. No. 5,756,020, U.S. PAT. No. 4,684,488, DE 196 54 829, EP 594 904, EP 407 927 and EP 131 414.

A common disadvantage of such predisclosed methods is that the precision with which a plastic product of a desired color can be produced is not typically sufficient to comply with the requirements of colorists and end users. To produce an appropriate plastic product, a certain degree of “trial and error” is therefore unavoidable before a composition of the compounded polymer is reached that is such that the desired color results. This is associated with appreciable time and cost expenditure.

Various calorimeters are known to the skilled artisan. DE 196 44 616 A1, for example, discloses a calorimeter that has a light source and a photocell for receiving diffusely reflected radiation from the surface of the specimen.

DE 196 44 617 A1 discloses a further method and a device for color measurement. The method of DE 196 44 617 A1 serves to measure the color of a specimen of granulated or pelletized material contained in a container by determining the diffuse reflection of a measurement beam emitted by the measurement head of the colorimeter onto the surface of the specimen.

U.S. Pat. No. 5 526 285, JP-A 0 90 333 49, JP-A 0 72 982 8 1 and FR-A 27 08 105 each disclose various further methods and devices for color measurement. Colorimeters are commercially available, for example, from the company Dr. Bruno Lange GmbH, Königsweg 10,14163 Berlin.

Such art-recognized calorimeters have the disadvantage that the precision of the color measurement fails by far to achieve the precision with which an observer can distinguish various color shades from one another. This is attributable to the fact that the human eye can distinguish between a substantially higher number of various colors than the best available calorimeters.

### SUMMARY OF THE INVENTION

The object of the invention is therefore to provide an improved system and method for determining the proportions of components of a formulation for producing a product, preferably a polymer, having a desired color and also a corresponding production method.

The object of the invention is achieved with the features of each of the independent patent claims. Preferred embodiments of the invention are specified in the dependent Patent Claims.

In accordance with the present invention, there is provided a network (herein referred to generally as a neuronal network) for determining at least one proportion of at least one component of a formulation and for producing a product having a pre-selected (or a certain) color comprising:

(a) a neuronal network (or neuronal processor) (1);

(b) at least one of,

(i) an input (2) for inputting at least one color coordinate of a component of the formulation into said neuronal network, and

(ii) an input (3) for inputting at least one pre-selected (or desired) color coordinate of said product into said neuronal network, and

(c) an output (4) for outputting a proportion of at least one component of said formulation from said neuronal network,

wherein said inputs (b)(i) and (b)(ii), and said output (c) are each independently connected (e.g., electronically and/or digitally) to said neuronal network.

In accordance with the present invention, there is also provided a method of training a neuronal network comprising the following steps:

(a) providing said neuronal network comprising,

(I) a neuronal network (or neuronal processor) (1);

(II) at least one of,

(i) an input (2) for inputting at least one color coordinate of a component of a formulation into said neuronal network, and

(ii) an input (3) for inputting at least one pre-selected color coordinate of a specimen into said neuronal network, and

(III) an output (4) for outputting a proportion of at least one component of said formulation from said neuronal network,

wherein said inputs (II)(i) and (II)(ii), and said output (III) are each independently connected to said neuronal network;

(b) measuring at least one color coordinate of a component of a first formulation;

(c) producing a first specimen with the components of said first formulation;

(d) determining at least one color coordinate of said first specimen,

(e) repeating steps (b), (c) and (d) with at least one further formulation and at least one further specimen produced therefrom, said further specimen having a color that is different than that of said first specimen;

(f) inputting the color coordinates of the specimens and the color coordinates of the components of said formulations as input parameters into said neuronal network by means of said inputs, and obtaining proportions of the components of said formulations as output parameters by means of said output of said neuronal network; and

(g) comparing the output parameters of said neuronal network with known proportions of components of said formulations, said neuronal network having neurones, and adapting the neurones of said neuronal network, thereby training said neuronal network.

In accordance with the present invention, there is further provided a method of producing a plastic injection molded article comprising the following steps:

(a) obtaining proportions of components of a formulation comprising a polymer, by means of the method as described above;

(b) compounding a polymer composition based on said formulation; and

(c) injection-molding the compounded polymer composition.

The features that characterize the present invention are pointed out with particularity in the claims, which are annexed to and form a part of this disclosure. These and other features of the invention, its operating advantages and the specific objects obtained by its use will be more fully understood from the following detailed description and accompanying drawings in which preferred embodiments of the invention are illustrated and described.

Unless otherwise indicated, all numbers or expressions, such as those expressing structural dimensions, quantities of ingredients, etc. used in the specification and claims are understood as modified in all instances by the term “about.”

### BRIEF DESCRIPTION OF THE DRAWINGS

FIG. 1 is a representative a block diagram of a first embodiment of a neuronal network according to the present invention;

FIG. 2 is a representative block diagram of a second embodiment of a neuronal network according to the present invention;

FIG. 3 is a representative flowchart (or algarithm) for obtaining training data for the neuronal network of FIG. 1;

FIG. 4 is a representative flowchart of an embodiment of a method of producing a product having a desired color according to the present invention;

FIG. 5 is a representative flow diagram illustrating the production of a color catalogue;

FIG. 6 is a representative schematic representation of two different pages of a color catalogue that may be used in the method of the present invention;

FIG. 7 is a representative page of a color catalogue with holes in the color master that allow for a facilitated visual comparison with a specimen;

FIG. 8 is a representative flowchart of a first embodiment of a method according to the present invention for the determination of color coordinates;

FIG. 9 is a representative flowchart of a second embodiment of the method according to the present invention for the determination of color coordinates;

FIG. 10 is a representative flowchart of an embodiment of a method according to the present invention for producing a digital color image; and

FIG. 11 is a representative schematic block diagram of a system according to the present invention for determining the color coordinates of a specimen and for producing a color image of the specimen.

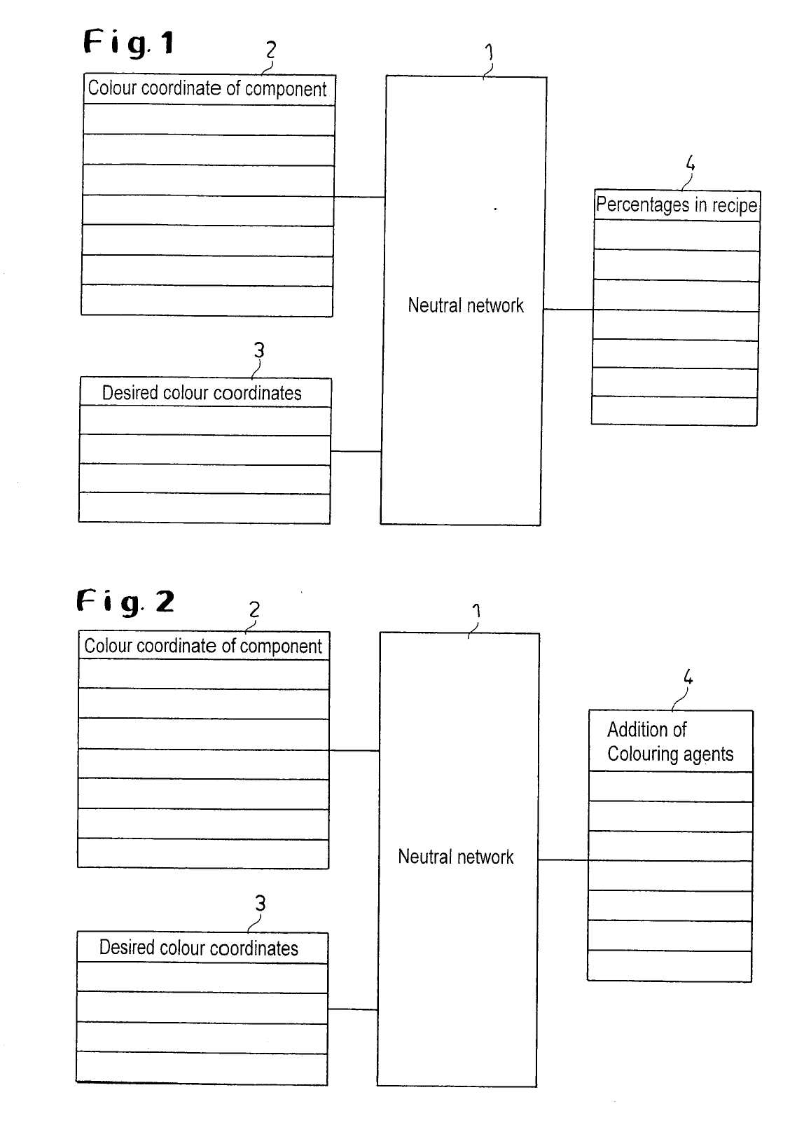

In FIGS. 1 through 11, like reference numerals designate the same components and process steps.

### DETAILED DESCRIPTION OF THE INVENTION

The invention makes it possible to select a formulation for the production of a product in such a way that a desired color of the product is met with a high degree of precision. This is of special advantage, in particular, for the production of plastic injection moldings.

According to the invention, an appropriately trained neuronal network is used to determine the proportions of components in a formulation. According to a preferred embodiment of the invention, the formulation relates to the proportions of the components of a polymer composition. Based on those proportions of the components of the formulation determined by means of the neuronal network, the polymer is then compounded for a subsequent injection-molding process.

According to a further preferred embodiment of the invention, the neuronal network has an input for one or more color coordinates of the components of the formulation. This assumes that an amount of predetermined components belongs to a formulation, the percentages of some or all the components of the formulation being variable in order to meet a certain hue precisely.

It is also possible to take account of fluctuations in color hues of the starting materials by means of the possibility for inputting color coordinates of the components of the formulation. This is essential, in particular, in the case of those components whose color is subject to certain statistical fluctuations, with the result that different supplier batches of the same component have slightly different color hues, for example, from white to yellow-tinted. The degree of deviation from white to yellow is in that case characterized, for example, by the so-called yellowness index.

The deviation of a component from its normal or average color can in that case be characterized, for example, by a one-dimensional color coordinate, such as, for example, the yellowness index. Alternatively, for example, three color coordinates according to CIELAB or another system can be determined with a colorimeter and corresponding inputs of the neuronal network can be allocated for the respective components.

The neuronal network furthermore has an input for the color coordinates of the desired color of the product, this involving, for example, three or four coordinates, depending on the chosen color coordinate system.

According to a further preferred embodiment, the formulation proportions of the individual components are regarded as fixed. In this case, only the amount of the dyestuffs and pigments to be added is variable. Instead of the proportions of the components of the formulation, the neuronal network outputs for this case only the added amounts of dyestuffs and/or pigments.

According to a further preferred embodiment of the invention, such a neuronal network is trained separately for every formulation. The neuronal network therefore has no input for specifying the formulation of the product and its components since these are regarded as fixed.

To train a neuronal network according to the invention, the color coordinates of the components from which a specimen is to be prepared are first determined. The specimen is then produced by means of a plastic injection-molding method with a certain formulation. The color coordinates of the specimen are then determined and this process is repeated for a modified formulation composition in order to produce a specimen having another color. The color coordinates of said specimen are then also determined in turn.

Furthermore, such specimens are produced with different batches of components in order to be able to take account of the variance in the color of the initial components. The neuronal network is then trained with the data obtained in this way, i.e. with the color coordinates of the components, the color coordinates of the specimens produced therewith and the proportions of the components of the respective formulation in each case.

Once such a neuronal network is available for a certain formulation, a product can be produced with very low expenditure from a plastic of this formulation having a precisely defined color. For this purpose, the color coordinates of the desired color of the product are inputted into the neuronal network, along with the color coordinates of the components from which the product is to be produced. The neuronal network determines from this the required proportions of the components of the formulation in order to achieve the desired color.

Pellets of the polymer are then produced in accordance with the formulation proportions determined in this way and the production of the product can be commenced immediately without the necessity of prior color matchings and laboratory experiments. This saves time and costs to a very appreciable extent and, furthermore, results in a constant quality even with fluctuating color of the components of different supplier batches.

To obtain the training data for the neuronal network, it is necessary to determine precisely the color coordinates of a specimen produced according to a certain formulation. For this purpose, color masters are used according to the invention as a comparison standard for the precise determination of the color coordinates of the color in a discrete color space.

For this purpose, a color space of interest is first subdivided by means of a color coordinate system into a number of discrete colors and a color master is produced for each of the discrete colors.

Such a color master can be produced by means of a pictograph. A pictograph is an appliance for producing a digital color image that is generated by means of laser beams on a special film. Such pictographs are commercially available, for example, from Fuji Photo Film Co. Ltd., Japan, in particular the Digital Image Printer Pictography 4000 Appliance.

According to a preferred embodiment of the invention, the various color masters are collated in a catalogue. Such a catalogue has an index corresponding to the respective color coordinates of the color master, that is to say each of the color masters can be accessed by means of the corresponding color coordinates in the catalogue itself. Preferably, each page of the catalogue has a two-dimensional portion comprising, for example, a four-dimensional color space, in particular CMYK color space, with the color masters that belong to said portion. Such a two-dimensional portion is obtained, for example, in that two coordinates are specified and the two other coordinates serve as parameters.

According to a preferred embodiment of the invention, a color measurement with a calorimeter is first performed to determine the color coordinates of a specimen. By means of the color coordinates obtained in this way, the appropriate master having the same color coordinate is accessed in the color catalogue. Preferably, the precision of the color catalogue extends substantially beyond the precision of the color measurement, that is to say the number of discrete colors in the color catalogue is substantially greater than the number of colors between which the colorimeter can distinguish. The color coordinates obtained by the color measurement are therefore initially only provisional and serve as a starting point for a fine matching with the colors in the color catalogue.

In a preferred embodiment of the invention, the user proceeds with the color coordinates obtained by the color measurement to the corresponding catalogue page that contains the color master with the color coordinates. The user then compares the specimen with said color master and, preferably, also with further color masters on the same catalogue page that is adjacent to the first mentioned color master. Preferably, this comparison takes place under standard conditions, that is to say under standard light, preferably according to ISO 3664.

In a further preferred embodiment of the invention, the color masters each have a hole in a central region. For a precise color comparison, the user places the specimen underneath the respective color master and consequently has a direct comparison between the color of the specimen surface and the color of the color master. On the basis of the visual comparison under standard conditions with the color master of the metrologically determined color coordinates of the specimen and the color masters adjacent thereto having color coordinates in the vicinity of the metrologically determined color coordinates, the user then finally determines the color coordinates of the specimen, which may deviate from the metrologically determined color coordinates because of the higher color resolution of the color catalogue compared with the calorimeter.

The determination of the provisional color coordinates by means of the calorimeter is particularly advantageous insofar as the user is given in this way a starting point for undertaking the visual comparison of the color masters in the catalogue with the specimen. Without such a starting point, the user would first have to find the best-fit catalogue page in an extremely extensive color catalogue, which is scarcely feasible in practice. By measuring the color coordinates with a calorimeter, the user can access the relevant catalogue page directly by means of the catalogue index in order to perform, starting from that point, color comparisons with color masters of adjacent color coordinates on the same or adjacent catalogue pages.

In a further preferred embodiment of the invention, the color coordinates determined in this way are inputted into a digital appliance (or apparatus) for producing a color image, for example into a pictograph. A precise reproduction of the color of the surface of the specimen can then be produced by means of the pictograph.

In a further preferred embodiment of the invention, the measurement of the color coordinates follows in a three-dimensional color coordinate system with the calorimeter. The color coordinates determined in the three-dimensional color coordinate system are then transformed into a four-dimensional color coordinate system. Suitable methods for transforming color coordinates between different color coordinate systems are disclosed per se, for example, in U.S. Pat. No. 6,108,442 and U.S. Pat. No. 6,137,596.

According to a further preferred embodiment of the invention, luminance image information of the specimen is furthermore determined, for example by recording a black-and-white image of the specimen or by means of a fine scanner that delivers an LCH image signal. The L-component, that is to say the luminance component, is then extracted from the LCH image signal and combined with the previously determined color coordinates in an image-processing program to form a resultant image information item. The C-component of an LCH image signal indicates the chrominance and the H component the color angle on a 360 degree color circle.

In this connection, the Adobe Photoshop Program, for example, which generates a resultant overall image from a black-and-white image and additional color information items in the form of color coordinates, may be used as image-processing program. Said resultant image information can be used in turn to produce a digital color image by means of a pictograph.

In this connection, it is of particular advantage that, in addition to the color information due to recording the luminance information, surface structures, textures and also surface gloss can also be reproduced in the resultant image information or in the digital color images.

In addition to using the color catalogue to determine the color coordinates of a specimen for the purpose of training the neuronal network, the color catalogue or the corresponding system may also be used to determine the color coordinates of the desired color of the product. For example, a customer supplies a color master to specify the desired color of the product that has to be met precisely. The color coordinates of said color master are then determined according to the invention using the color catalogue and used as input parameters for the neuronal network.

The invention is explained in greater detail below with reference to a preferred exemplary embodiment.

FIG. 1 shows a neuronal network 1 having the inputs 2 and 3 and also the output 4. The neuronal network 1 relates to a certain formulation for the production of plastic injection molding. The individual components of the formulation are fixed. One or more components of the formulation have variable proportions in order to produce different color hues of the polymer.

The input 2 serves to input color coordinates of the components of the formulation. This serves to take account of color fluctuations to which a certain component is statistically subject, i.e., a component of the polymer supplied for the production of a certain product does not always have the same color, but more or less great color fluctuations from batch to batch.

Said fluctuations may be typically manifested depending on component, for example instead of white more or less yellow-tinted or instead of white more or less blue-tinted, etc. To determine the color deviation of a certain component from its average hue or standard hue, a one-dimensional specification may be sufficient in this connection, such as, for example, the yellowness index. However, three or four color coordinates may also be determined with a calorimeter.

For each component in the formulation whose color fluctuation has to be taken into account, an entry is provided in the input 2. Preferably, this involves all the components of the formulation.

The input 3 serves to input the color coordinates of the desired (or pre-selected) color of the product. This may involve specifying, for example, three or four color coordinates, depending on the chosen color coordinate system.

The neuronal network 1 calculates the proportions of the components in the formulation from these input values of inputs 2 and 3 so that the desired color can be produced using the respective batches of components. For example, the proportions are percentages of the components with respect to the composition of the formulation.

FIG. 2 shows an alternative embodiment in which corresponding elements are characterized by the same reference symbols as in FIG. 1. The neuronal network 1 in FIG. 2 also relates again to a certain formulation having defined components. Said components also include dyestuffs and pigments. As a departure from the embodiment in FIG. 1, it is assumed in this case that only components of the formulation that are dyestuffs or pigments have variable proportions and that all other components have a fixed proportion. The appropriately trained neuronal network 1 therefore supplies at its output 4, in contrast to the neuronal network 1 of FIG. 1, only a specification relating to the amount of dyestuffs and/or pigments to be added since the proportions of the further components are fixed.

Furthermore, it is also possible to train a neuronal network in such a way that the formulation, i.e., the amount of the components, is also variable, but this requires an increased expenditure in regard to generating the data needed for training the neuronal network.

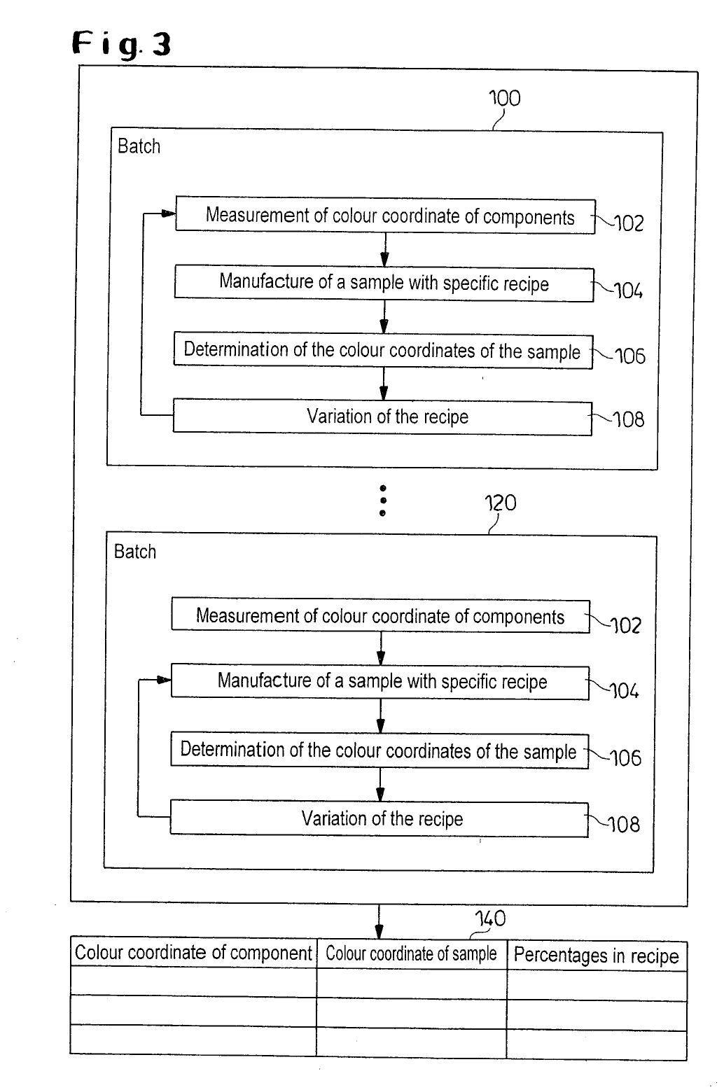

FIG. 3 shows a preferred embodiment in regard to a method for generating training data for training the neuronal network 1 of FIG. 1.

The method comprises a step 100 for a first batch and a step 120 for a second batch and also further steps, not shown in FIG. 3, for one or more further charges of components of the formulation.

The step 100 comprises a sequence involving steps 102 to 108. In step 102, the color coordinates of the components of the formulation are measured. In this case, a relatively coarse measurement, for example in a one-dimensional color coordinate system, is sufficient, for example, to determine the so-called yellowness index.

In step 104, one or more specimens are then produced with said components in a plastic injection-molding method, i.e. the components are compounded in accordance with a certain formulation, and an appropriate pelletized material is produced, which is then used to produce the specimen. Important in this connection is that the same components for which the color coordinates have been measured in step 102 are used to produce the specimen.

In step 106, the color coordinates of a specimen produced in step 104 are determined as precisely as possible. In step 108, the formulation is then modified in order to produce a specimen of another color. The formulation can be modified by altering the proportions of one or more of the components of the formulation.

The color coordinates are then also determined precisely again for said specimen produced with the modified formulation. This process is repeated a few times for different modifications of the formulation, i.e., for different colors. In this connection, the modifications in the formulation can be chosen statistically in order to cover a raster of different colors.

The same steps 102 to 108 also proceed in step 120, but with reference to another batch of components. The data thus obtained are outputted, for example, in the form of a table in step 140. The table comprises in each row the color coordinates of the components of the respective batch that has been used to produce the specimen, the color coordinates of said specimen, which are as precise as possible, and also the proportions of the components in the formulation for compounding the polymer for producing the respective specimen.

To train the neuronal network 1 in FIG. 1, this table is then accessed in order to retrieve the input parameters, necessary for the training, for the inputs 2 and 3. The resultant proportions of the components in the formulation that are outputted by the neuronal network 1 at its output 4 are then compared with the actual proportions in the table. In the event of a deviation between the predicted and the actual value, the weightings of the neurones of the neuronal network 1 are adapted accordingly, as is known to the skilled artisan.

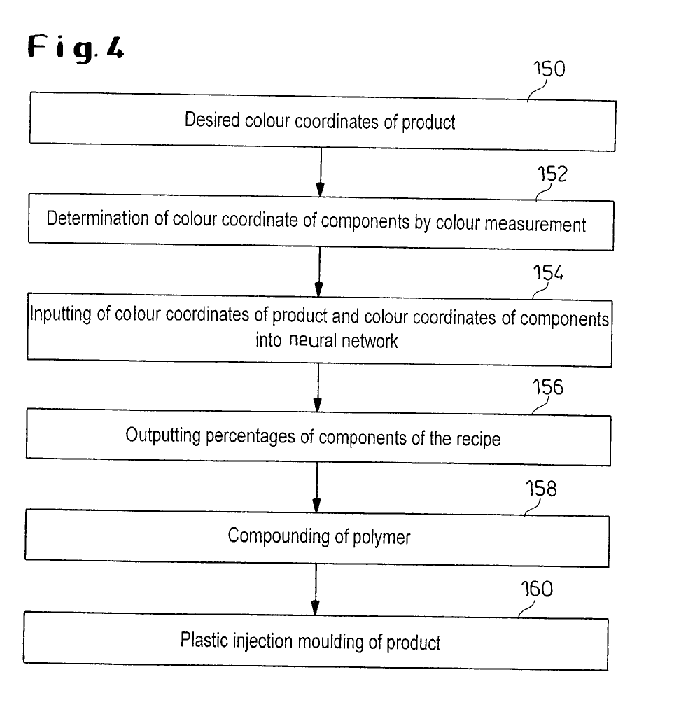

FIG. 4 shows a flowchart of a method according to the invention for the production of a plastic injection molding. In step 150, the desired color coordinates of the product are first specified. This can be done by determining the respective color coordinates on the basis of a color master that corresponds to the desired color, or by taking the desired color having the corresponding color coordinates directly from a color catalogue system.

In step 152, the color coordinates of the components used to produce the product are determined in order also to detect color fluctuations in the respective raw materials.

In step 154, the desired color coordinates of the product and also the color coordinates of the components are inputted into a neuronal network (e.g., neuronal network 1 of FIGS. 1 and 2). In step 156, the neuronal network outputs, for example, the percentages of the components in the formulation for producing the desired color.

In step 158, the polymer is compounded with the appropriate percentages of the components and a pelletized material produced. The plastic injection molding of the desired product then takes place therewith in step 160.

A color adjustment or color matching before or during the production and also the performance of laboratory tests to determine suitable percentages of the components for producing the desired color can therefore be omitted.

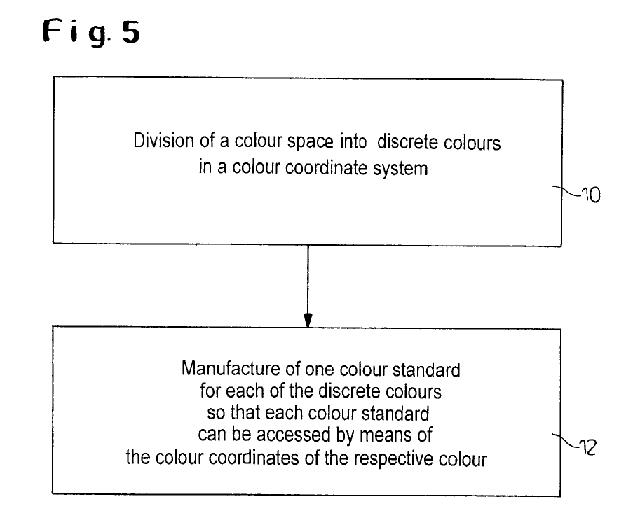

FIG. 5 shows a flowchart for producing a color catalogue according to the invention. In step 10, a color space of interest is first subdivided into discrete colors by means of a color coordinate system. In this connection, known color coordinate systems, such as, for example, the RGB, CMY, LCH or CMYK systems or another color coordinate system, are suitable. Further color coordinate systems are defined by the Commission Internationale de I‘Éclairage.

Without intending to limit the present invention and unless otherwise noted, in the description as herein follows, the CMYK system is used for the color coordinate system of the color masters and of the color catalogue.

In step 12, a color master is produced for each of the discrete colors of the color space subdivided by the color coordinate system. The number of color masters is determined in this case by the quantization intervals for the discretization of the color space. Each of the color masters is unambiguously identified by its color coordinates in the chosen color coordinate system. The color coordinate of the color master serves as an index or as a key for accessing the color master if the color coordinates are known.

Preferably, a plurality of such color masters are compiled on one catalogue page, a catalogue page reproducing a two-dimensional portion of the multidimensional color coordinate system.

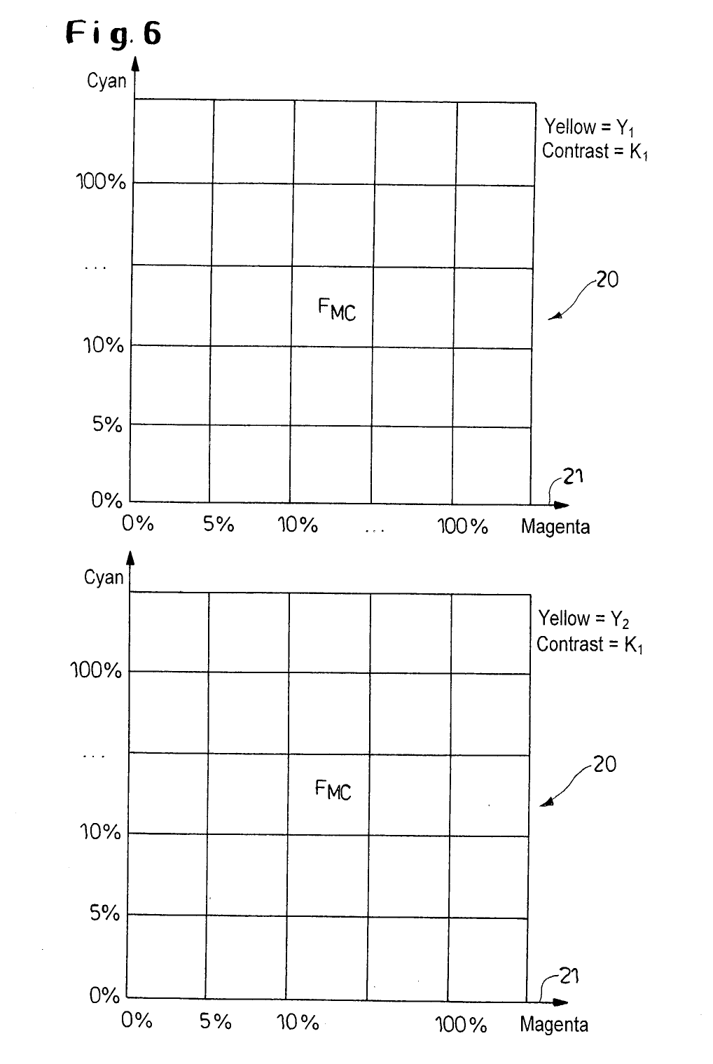

This is explained in more detail with reference to FIG. 6. FIG. 6 shows a page 20 of the color catalogue with a Cartesian coordinate system 21. The abscissa of the Cartesian coordinate system 21 specifies the M-proportion, that is to say the magenta proportion as a percentage, and the ordinate of the Cartesian coordinate system 21 specifies the C-proportion, that is to say the cyan proportion, likewise as a percentage. The page 20 is a portion of the discrete color space, the cyan and magenta proportions each varying between zero and one hundred per cent in the corresponding section through the color space and the Y, that is to say yellow, and the K, that is to say contrast proportions, being constant. In the example considered, the proportion Y has the value Y1 and the proportion K has the value K1 for all the colors of this portion of the discrete color space.

The color space in the exemplary embodiment shown is quantized in five percentage steps, smaller or larger steps also being capable of being chosen depending on the precision requirement.

The page 20 therefore shows a matrix of color masters in which each of the color masters has the same Y-component Y1 and the same contrast component K1 and only the magenta and cyan proportions vary. This produces various color masters F_{MC} that each have a homogeneous discrete color with a certain percentage of magenta and a certain percentage of cyan, and also the constant proportions Y1 and K1 for the page 20. A certain color master can therefore be accessed by means of its CMYK color coordinates in the catalogue in that the catalogue page 20 is chosen with the respective yellow and contrast coordinates and the color master with the correct magenta and cyan proportions is then chosen on said catalogue page 20.

FIG. 6 shows a further page 20′ of the color catalogue that gives another portion of the discrete color space, namely for the yellow proportions Y2 and contrast proportions K1.

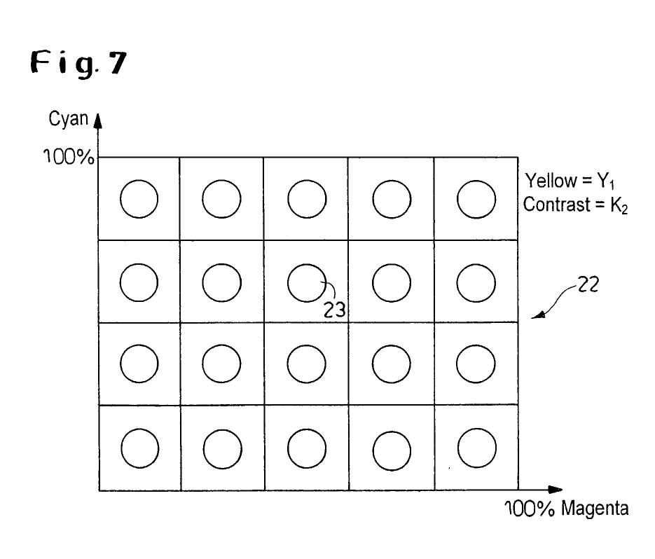

FIG. 7 shows a corresponding page 22 of such a color catalogue. In the embodiment of FIG. 7, each color master of the page 22 has a hole 23 in a central region. A hole 23 serves for the convenient comparison of the color of the color master with the color of the surface of the specimen whose precise color coordinates are to be determined. For such a visual comparison, the specimen is placed underneath the color master and viewed through the hole in the color master.

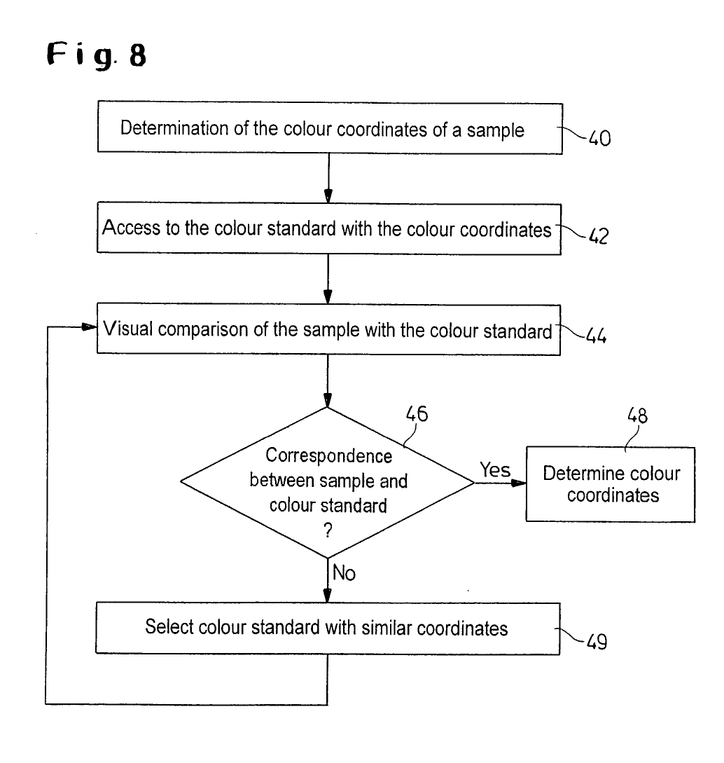

FIG. 8 shows a flowchart of a method of determining the color coordinates.

In step 40, the color coordinates of the specimen are first determined with a calorimeter. The corresponding color master is then accessed with said color coordinates in step 42. This is compared visually in step 44 with the specimen. Preferably, this comparison is made under standard conditions, that is to say under standard light.

In step 46, the user decides whether the specimen corresponds to the color master. If this is the case on the basis of the visual comparison, the color coordinates of the color master are at the same time the color coordinates of the specimen and the color of the specimen is therefore determined.

If the opposite is the case, the user chooses in step 49 another color master that has similar color coordinates. This may be, for example, one or more color masters of the same page (e.g., page 20 or page 22 in FIGS. 6 and 7, respectively), that are adjacent to the color master having the metrologically determined color coordinates. It may, however, also involve color masters of adjacent coordinates on different catalogue pages.

Such a color master chosen in step 49 is then compared in turn visually in step 44 with the specimen. This process is repeated until the color master having the best color matching with the specimen has been found by the user.

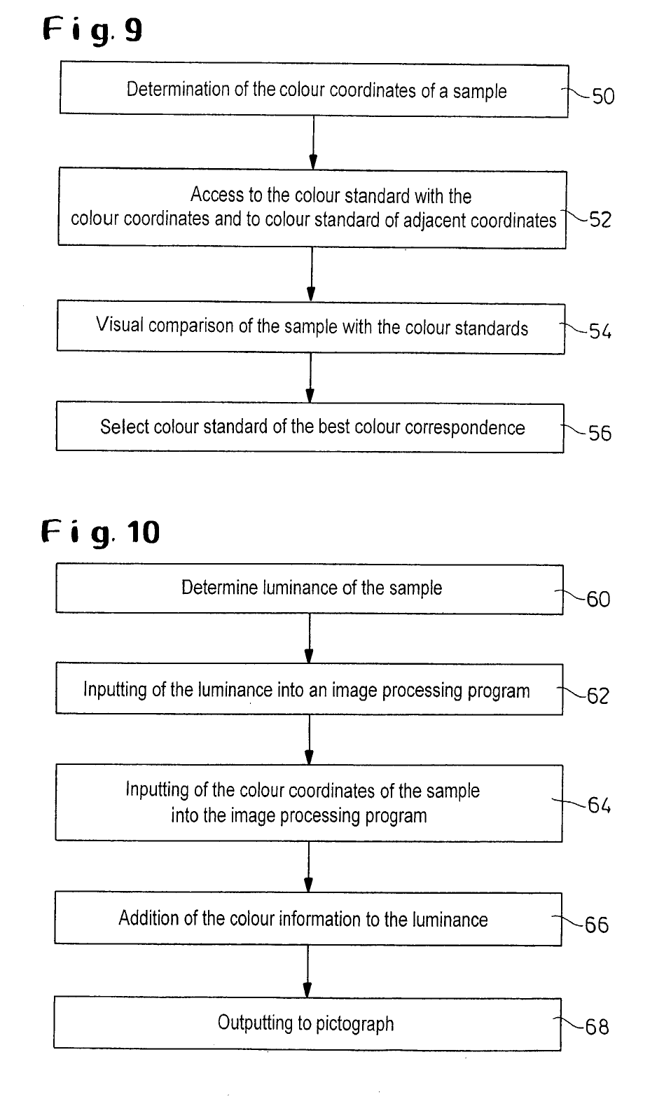

FIG. 9 shows an alternative embodiment of the method of FIG. 8, in which the color coordinates of the specimen are again first determined metrologically in step 50. In step 52, the color master is then accessed in the catalogue that has said color coordinates and also further color masters are accessed with color coordinates adjacent thereto. This preferably involves color masters of the same catalogue page.

Said color masters are visually compared in step 54 with the specimen in order to determine the best color match (step 56).

FIG. 10 illustrates a corresponding method of producing a digital color image. In step 60, luminance of the specimen is determined, preferably by means of a fine scanner that delivers an LCH signal. In this case, the luminance results from the L-component of the signal delivered by the fine scanner.

Said luminance information is inputted in step 62 into an image-processing program. In this way, a black-and-white depiction of the specimen is obtained which comprises texture information items and/or gloss information items. In step 64, the color coordinates of the specimen determined previously are likewise inputted into the image-processing program and combined in step 66 with the luminance image information to form a resultant image information item. The image generated digitally in this way in step 66 is then outputted in step 68 on a suitable device that satisfies the precision requirements. A pictograph, for example, can be used for this purpose.

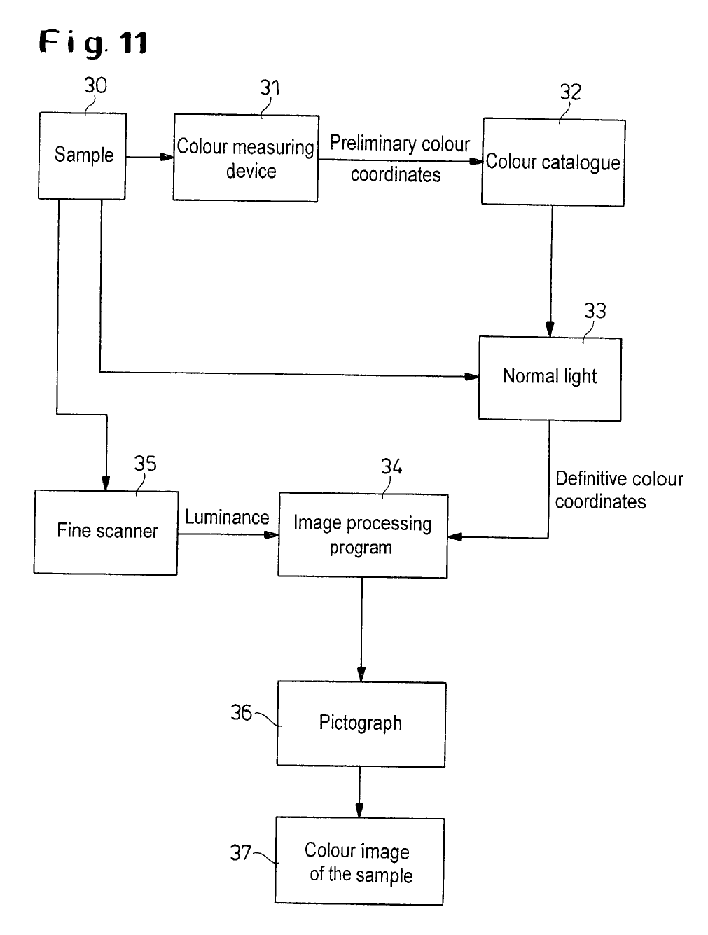

FIG. 11 shows a suitable system that may be used in the method of the present invention. A calorimeter 31 serves to determine the color coordinates of a specimen 30. A color catalogue 32 that comprises the discrete colors of a quantized color space is then accessed by means of the metrologically determined, provisional color coordinates of the specimen 30, the individual color masters being accessible by means of their color coordinates in the color catalogue 32.

The color catalogue 32 may comprise, for example, various pages that each reproduce a two-dimensional portion of the multidimensional color space (e.g., pages 20, 20′ and 22 of FIGS. 6 and 7, respectively). The color master selected in this way is then compared with the specimen 30 under a standard light appliance 33. From this visual comparison with the color master or further color masters with adjacent color coordinates, the final color coordinates of the specimen 30 then follow. These are inputted into an image-processing program 34.

Furthermore, an item of luminance image information that is likewise inputted into the image-processing program 34 is generated by means of a fine scanner 35. The image-processing program 34 combines the luminance image information with the color coordinates to form a resultant image information item that is outputted through a pictograph 36 in order to produce a color image 37 of the specimen.

List of reference symbols

Neuronal network 1

Input 2

Input 3

Output 4

Step 10

Step 12

Page 20

Page 20

Cartesian coordinate system 21

Page 22

Hole 23

Specimen 30

Colorimeter 31

Color catalogue 32

Standard light appliance 33

Image-processing program 34

Fine scanner 35

Pictograph 36

Color image 37

Step 40

Step 42

Step 44

Step 46

Step 48

Step 49

Step 50

Step 52

Step 54

Step 56

Step 60

Step 62

Step 64

Step 66

Step 68

Step 100

Step 102

Step 104

Step 108

Step 120

Step 140

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

What is claimed is:

1. A neuronal network for determining at least one proportion of at least one component of a formulation and for producing a product having a pre-selected color comprising:
(a) said neuronal network;
(b) at least one of,
(i) an input for inputting at least one color coordinate of a component of the formulation into said neuronal network, and
(ii) an input for inputting at least one pre-selected color coordinate of said product into said neuronal network, and
(c) an output for outputting a proportion of at least one component of said formulation from said neuronal network,
wherein said inputs (b)(i) and (b)(ii), and said output (c) are each independently connected to said neuronal network.

2. The neuronal network of claim 1 wherein said components, whose proportion is determined, are selected from at least one of dyestuffs and pigments.

3. A method of training a neuronal network comprising the following steps:
(a) providing said neuronal network comprising,
(I) said neuronal network;
(II) at least one of,
(i) an input for inputting at least one color coordinate of a component of a formulation into said neuronal network, and
(ii) an input for inputting at least one pre-selected color coordinate of a specimen into said neuronal network, and
(III) an output for outputting a proportion of at least one component of said formulation from said neuronal network,
wherein said inputs (II)(i) and (II)(ii), and said output (III) are each independently connected to said neuronal network;
(b) measuring at least one color coordinate of a component of a first formulation;
(c) producing a first specimen with the components of said first formulation;
(d) determining at least one color coordinate of said first specimen,
(e) repeating steps (b), (c) and (d) with at least one further formulation and at least one further specimen produced therefrom, said further specimen having a color that is different than that of said first specimen;
(f) inputting the color coordinates of the specimens and the color coordinates of the components of said formulations as input parameters into said neuronal network by means of said inputs, and obtaining proportions of the components of said formulations as output parameters by means of said output of said neuronal network; and
(g) comparing the output parameters of said neuronal network with known proportions of components of said formulations, said neuronal network having neurones, and adapting the neurones of said neuronal network, thereby training said neuronal network.

4. The method of claim 3 wherein the steps (b), (c) and (d) are performed for different batches of components.

5. A method of determining the proportions of components in a formulation for producing a product having pre-selected color coordinates comprising the following steps:
(a) providing a neuronal network comprising,
(I) said neuronal network;
(II) at least one of,
(i) an input for inputting at least one color coordinate of a component of a formulation into said neuronal network, and
(ii) an input for inputting at least one pre-selected color coordinate of a specimen into said neuronal network, and
(III) an output for outputting a proportion of at least one component of said formulation from said neuronal network,
wherein said inputs (II)(i) and (II)(ii), and said output (III) are each independently connected to said neuronal network;
(b) determining at least one color coordinate of at least one component of said formulation by means of colorimetry;
(c) inputting pre-selected color coordinates of said product, and inputting the measured color coordinates of the components of said formulation into said neuronal network by means of said inputs; and
(d) obtaining the proportions of the components of the formulation from said output of said neuronal network.

6. A method of producing a plastic injection molded article comprising the following steps:
(a) obtaining proportions of components of a formulation comprising a polymer, by means of the method of claim 5;
(b) compounding a polymer composition based on said formulation; and
(c) injection-molding the compounded polymer composition.

7. The method of claim 3 wherein step (d) further comprises:
(i) measuring the color coordinates of the specimen;
(ii) providing access to at least one color master having color coordinates, said access being obtained by means of the color coordinates of said color master; and
(iii) comparing the color master with the specimen to verify the color coordinates of the specimen.

8. The method of claim 3 wherein step (d) further comprises:
(i) measuring the color coordinates of said specimen;
(ii) providing access to a color master having color coordinates and to at least one further color master having adjacent color coordinates, said access being obtained by means of the color coordinates and adjacent color coordinates of each of said color master and further color master; and
(iii) comparing the color master and the further color master with said specimen, and determining which of said color master and said further color master best matches the color of said specimen.

9. The method of claims 7 or 8 wherein comparison step (iii) is performed visually.

10. The method of claim 9 wherein comparison step (iii) is performed under standard light.

11. The method of claim 7 wherein the color master has a hole in a central region, and a surface region of the specimen is viewed through the hole for comparison with the color master.

12. The method of claim 7 wherein the color masters are stored in a catalogue system having pages, the catalogue system is indexed by means of the color coordinates of each color master, and a color master in the catalogue system is accessed by means of its color coordinates.

13. The method of claim 12 wherein each page of the catalogue system comprises a two-dimensional portion of a discrete color space.

14. The method of claim 12 wherein each page of the catalogue system comprises a three-dimensional discrete color space.

15. The method of claim 12 wherein each page of the catalogue system comprises a four-dimensional discrete color space.

16. The method of claim 7 wherein step (i) comprises measuring the three-dimensional color coordinates of the specimen, and then transforming the three-dimensional color coordinates into four-dimensional color coordinates, and in step (ii) said color master has four-dimensional color coordinates, and access to the color master is obtained by means of the four-dimensional color coordinates.
